(19) United States
(12) Patent Application Publication
(10) Pub. No.: US 2019/0014619 A1
(43) Pub. Date: Jan. 10, 2019

(54) RESISTIVE ELEMENT APPLIED TO HEATING EQUIPMENT

(71) Applicant: ACTION TECHNOLOGY INDUSTRIA E COMERCIO DE ELETROELETRONICOS LTDA, Varginha (BR)

(72) Inventor: Roberto Jun IKESAKI, Sao Paulo (BR)

(21) Appl. No.: 16/028,829

(22) Filed: Jul. 6, 2018

(30) Foreign Application Priority Data
Jul. 6, 2017 (BR) 10 2017 014663 4

(51) Int. Cl. H05B 3/26; H05B 1/02

(52) U.S. Cl. CPC H05B 3/265; H05B 2203/004; H05B 1/0252

(57) ABSTRACT

A resistive element applied to heating equipment significantly increases the efficiency and savings in heating equipment such as hair drying equipment and other similar equipment. A resistive element has at least one flat and aligned profile resistive element mounted in a wave-shaped format. At least one support structure with four radial vanes is mounted and houses, aside from the resistive element units, the respective connection terminals, a thermostat, and required electrical wires.

### BACKGROUND OF THE DISCLOSURE

### 1. Field of the Disclosure

This invention patent specification particularly refers to a new resistive element, built from an absolutely innovative formal structure, notably developed to be applied to hair drying heating equipment and other similar equipment that require heat to use, said resistive element including innovative formal features that provide, in practice, higher efficiency in utilization as well as increased power savings, belonging specially to the field of ohmic resistance heating devices and components, heating elements including a surface that essentially extend across two dimensions, for example, heating plates, heating elements structurally combined to coupling elements or to supports, hair drying devices and accessories, electrically heated air production devices, handheld drying devices, for example, air dryers or similar equipment.

Said resistive element may be used in equipment that require a certain amount of heat to be generated and maintained inside said equipment, either for air heating, in the case of hair dryers, or for heating ceramic plates, in the case of hair straightening devices or any other similar uses that require using a high performance resistive element capable of heating and maintaining a high temperature for use.

### 2. Description of Related Art

The current state of the art comprises modern equipment that feature resistive elements, which are, as a rule, shaped through usually linear filaments, with said resistive element models failing to achieve proper performance and, therefore, having their utility restricted, as they fail to provide the required efficiency in heating and maintaining heat inside the equipment, and having greatly reduced useful life due to this fact.

Hair dryers and other equipment that function based on a heating principle normally feature electric resistances which, when heated, provide, through heat exchange effects, heating of the airflow that circles through said resistances.

For hair dryers and equipment comprised in the state of the art, electric resistances are usually mounted onto a support structure, around which the helical body that defines electric resistance must be properly placed and fixed.

The electric resistances of the state of the art feature a helical and malleable physical constitution, which requires use of specific machines and equipment for handling and installation.

In addition, from an operational viewpoint in which this resistance model is used, said resistances may also be assembled manually, which proves to be time-consuming and increases respective operational cost, thus increasing the final cost to the customer.

### BRIEF DESCRIPTION OF THE DISCLOSURE

With the aforementioned issues in mind, and striving to provide improvements to the consumer market, the inventor created and developed THIS “RESISTIVE ELEMENT APPLIED TO HEATING EQUIPMENT”, which should stand out amongst its counterparts and establish its preference in the consumer market due to the fact that it features, as its primary objective, a resistive element of flat laminar structure and wave-shaped alignment, previously defined for use in electric equipment, obtained via a stretching process and deriving from various forms, “blank”.

Another objective of THIS invention patent application refers to the manufacturing process of said resistive element, said process being particularly used in powering the embodiment of the resistive element, object of this patent application. In addition, another important objective of said resistive element applied to heating equipment is to enable the dimensions of said on the same construction platform of standard resistances, built in helical shape, to reach ideal working temperature, depending on the equipment, with at least a 35% reduction in power consumption. Another objective of the present patent application is to provide a device including a flat resistive element, which features a shaping pattern that maximizes the area of contact with the fluid media to be heated (air, in the case of hair dryers and similar equipment).

Said resistive element is mounted on an insulating material structure, combined with internal ducts for concentrated direction of the heat flow.

The flat profile resistive element is produced through a stretching or wire drawing process in a flat profile tool, intended for use as replacement to standard helical-shaped electric resistances, either in hair dryers and similar equipment, or other types of heating equipment, the flat profile resistive element may be produced from conductor sections of various shapes, as a “blank” from a strip or coil made of a material alloy that features a known resistive coefficient.

Hair dryers and other equipment that function based on a heating principle normally feature electric resistances which, when heated, provide, through heat exchange effects, heating of the airflow that circles through said resistances.

### BRIEF DESCRIPTION OF THE DRAWINGS

In order to complement this invention and achieve better understanding of the features of this invention, and according to a preferred practical application of said invention, the following a set of drawings is attached to the invention, in which, in an exemplified manner, though not limiting, the functionality of this invention is represented:

FIG. 1 shows a perspective view of the resistive element applied to a hair drying type equipment.

FIG. 2 shows an exploded perspective view of the support structure on which the resistive element is mounted, in addition to the resistive element itself.

FIG. 3 shows a perspective view of a specific detail of the applied resistive element.

FIG. 4 shows an expanded detail, taken from FIG. 3, such as indicated by arrow “A” on FIG. 3, of a section of the resistive element, showing the airflows.

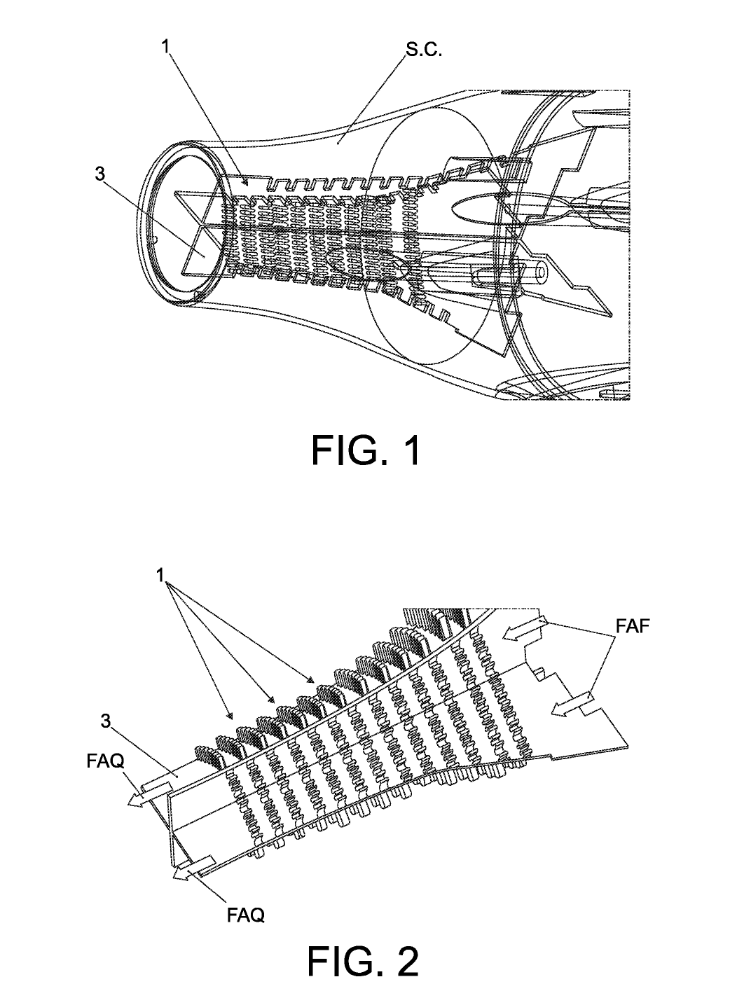

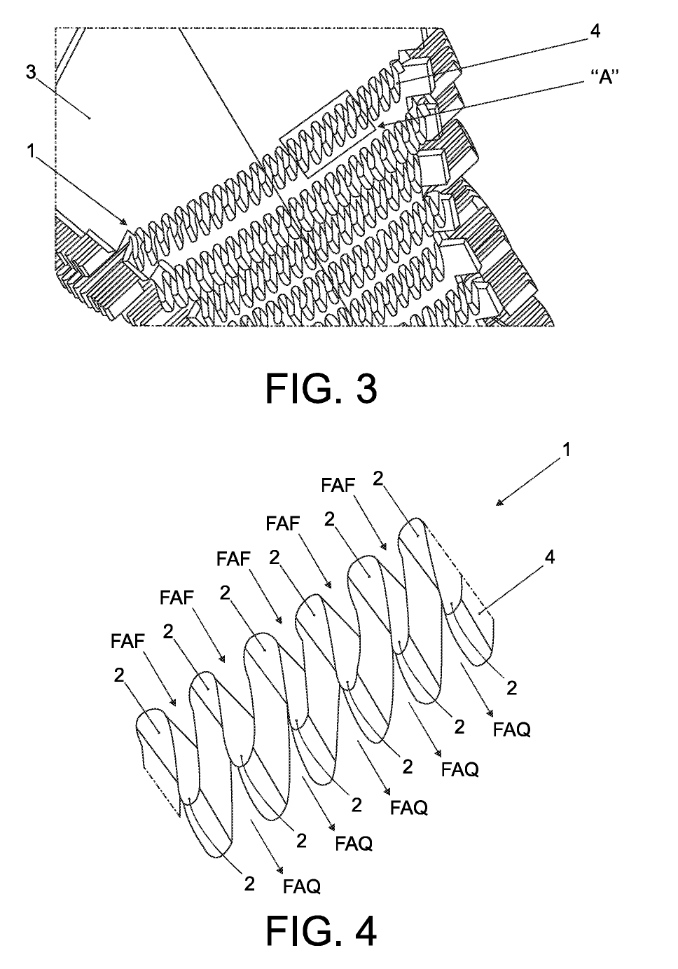

### DETAILED DESCRIPTION OF THE DISCLOSURE

In accordance with the aforementioned figures, this invention patent application, “RESISTIVE ELEMENT APPLIED TO HEATING EQUIPMENT”, features a resistive element 1 of a flat and aligned profile assembled in a wave-shaped format 2, in which a certain number of support structure units 3, each including four radial vanes, is mounted and able to be used in a hair dryer model SC or any other similar equipment, considering that said support structure 3 receives, as well as the units of the resistive element 1, the respective connection terminals and a thermostat, in addition to electrical wires required to power the resistive elements 1.

Conceptually, the resistive element 1 is mounted on stamped support structures 3 radially placed with each other, featuring, for this purpose, four vanes manufactured in demicanite or other insulating material with similar characteristics.

Thus, the resistive element 1 with a flat profile and wave-shaped alignment 2 features a substantially higher efficiency regarding conventional resistances.

In a practical way, the flat profile resistive element 1, when used, for example, in a hair dryer SC powered with a standard 127 or 220 V voltage, generates around 1300 W in power due to the cold airflow FAF passing in between the resistive elements 1 of a hair dryer SC, for example, which is optimized due to its laminar wave-shaped format 2, receiving cold air FAF and delivering, therefore, an amount of hot air in the form of a hot airflow FAQ that is higher and more efficient, with less power consumption.

The resistive element 1, object of this invention patent application, when applied to a hair dryer SC, for example, and when set up in its maximum combination of temperature and airflow, provides around 35% in power savings if compared to the power of other devices comprised in the state of the art which, on the other hand, often require generating between 2100 and 2200 watts of power to be able to deliver the same work temperature.

The low power consumed by the flat profile resistive element 1 is harnessed much more efficiently, in face of the higher concentrated heat generation, resulting from the wave-shaped format 2 of said profile.

The resistive value of the flat profile is significantly higher, providing less power consumption and comparable work temperature to the other versions comprised in the state of the art, that feature a higher power consumption.

Another fundamental aspect in the concept of the resistive element 1, object of this invention patent application, is that the flat profile resistive element 1 is obtained through a stretching process and the product obtained via said process allows establishing different shapes, thus demanding a higher flexibility for placement in the spaces available within a design, substantially decreasing difficulties in placement, which are common in other well-known equipment in the consumer market.

The U or V wave-shaped format 2 may be obtained through specific forming machinery, enabling relatively accurate sizes and widespread repeatability.

The flat profile resistive element 1 is obtained via a metal alloy strip 4 with a previously known resistive coefficient.

It should be highlighted that the flat profile and wave-shaped 2 resistive element 1, however, is not limited to this format, considering that the setting described herein was specifically developed for use in hair dryers SC, and while it does not constitute a limiting factor to the use of the resistive element 1 for this type of embodiment, other shape configurations may be demanded, provided the main characteristics of this resistive element 1 are respected, namely flexibility, placement onto a support structure manufactured in demicanite or other insulating material of equivalent features, and laminar shape structure.

In the aforementioned use example, in which the resistive element 1 is applied to a hair dryer SC, the amount of units/waves 2 or resistive element units 1 may vary to a greater or lesser extent, depending on the technical requirements of its specific embodiment.

Although this invention is detailed herein, it is important to note that its embodiment is not limited to the details and steps described herein. The invention is able to be applied in other models and to be practiced or executed in various ways. It should be understood that the terminology used herein is intended for description, and not as limiting.

1-7. (canceled)

8. A resistive element applied to heating equipment, the resistive element comprising:
at least one flat and aligned profile resistive element mounted in a wave-shaped format on which at least one support structure unit with four radial vanes is mounted and able to receive, aside from the resistive element unit, one or more respective connection terminals and a thermostat, as well as electrical wires.

9. The resistive element applied to heating equipment according to claim 1, wherein the at least one support structure unit is a plurality of stamped support structures placed radially with each other and having four vanes manufactured in demicanite.

10. The resistive element applied to heating equipment according to claim 1, wherein the flat profile resistive element provides between 30% and 40% reduction in power consumption.

11. The resistive element applied to heating equipment according to claim 1, wherein the resistive element is obtained through a stretching process.

12. The resistive element applied to heating equipment according to claim 1, wherein the resistive element is flexible and adaptable in shape.

13. The resistive element applied to heating equipment according to claim 1, wherein the resistive element is manufactured in a zigzag shape.

14. The resistive element applied to heating equipment according to claim 1, wherein the resistive element is used in hair dryers.
